(19) United States
(12) Patent Application Publication
(10) Pub. No.: US 2005/0018645 A1
(43) Pub. Date: Jan. 27, 2005

(54) Utilization of geographic location information in IP addressing

(76) Inventors: Kai Mustonen, Oulu (FI); Keijo Lahetkangas, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/717,600

(22) Filed: Nov. 21, 2003

Related U.S. Application Data
(63) Continuation of application No. PCT/FI02/00443, filed on May 22, 2002.

(30) Foreign Application Priority Data
May 22, 2001 (FI) 20011075

(51) Int. Cl. H04J 3/24

(52) U.S. Cl. 370/349; 370/474

(57) ABSTRACT

The present invention teaches a method for generating geographical location based on addresses where the address is divided to prefix and suffix. The suffix portion is administrated locally. In addition to the geographical location information the locally administrated portion can consist other information such as a device number. The geographical location information assigned to the suffix can be two or three dimensional.

### FIELD OF THE INVENTION

The present invention relates to data communications. Particularly the present invention relates to utilization of geographic location information in IPv6 (Internet Protocol, Version 6) addressing

### BACKGROUND OF THE INVENTION

In the Internet data communications the commonly used protocol for data transmission is internet protocol (IP). The rapid growth of the Internet has created new demands for protocol. The older version 4 of the internet protocol does not fulfill these requirements. The version 6 was implemented to solve these restrictions caused by version 4.

The changes from version 4 to version 6 can be divided to five main categories. The most significant of these concerning to the present invention is the expansion of the addressing capabilities. The address size has grown from 32 bits to 128 bits to support more levels of addressing hierarchy, a much greater number of addressable nodes, and a simpler auto-configuration of addresses.

Besides of the address space expansion in version 6 changes includes a header format simplification, improved support for extensions and options, flow labeling capability and authentication and privacy capabilities. The full description can be studied from IETF RFC 2460 (Request for comments).

The IP addressing is organized according to the IETF recommendations. The main principle is that the IPv6 addresses are divided in two parts: Prefix and Suffix. In the IPv6 networks the prefix part of the. address indicates uniquely a certain link or subnet. Typically the routers are organized so that they know the prefix addresses which are allocated for the router, and the router routes the received packets to respective links or subnets. The packets, which are not targeted to any link or subnet directly, connected to the router, are routed according to routing tables to other routers. The routers are typically connected to each other with multi level hierarchical structure.

Also connections between “same level” routers with direct connections are possible if routing tables are organized accordingly.

The suffix part of the address indicates a host in the link. Typically a link in IP network is an Ethernet Local Area Network (LAN) or a Wireless Local area Network (WLAN). So each computer connected to the IP network has an address, which consists of a prefix and a suffix. The prefix part indicates one router port where the respective link is connected. In the link the computers and other network components are addressed with suffix address (=link address). The Suffix address has to be a unique address in the link.

In IPv6 network the stateless address auto configuration of the network is managed so, that the hosts connected to the link adopt their link address from the MAC address of the network card. MAC addresses are supposed to be unique as the MAC addresses to network cards are given to cards according to EUI-64 standard. This standard requires manufacturers of the network cards to follow the standard and give unique address to network card from the address space allocated for them. The router advertises its address to the link and so basically any computer can auto configure itself to the network by adopting the IP prefix part of the address from the router advertisement and by adopting the link address from the MAC address. Other way for address auto configuration according to the IPv 6 recommendations is the statefull auto configuration, where a central DHCPv6 server allocates addresses for hosts on request.

The utilization of the geographical location information is taught in publications WO 0122656 and WO 0027091. With wide address space of the lPv 6 a unique address can be generated from the location information. When the location information is coded to the address it is very easy to harness in location depended applications. WO 0122656 teaches a method in which the location information is. assigned to prefix portion of the IPv6 address.

The drawback in the prior art addressing is, that the auto configuring is not always possible. The MAC address can have duplicates; so several cards can in practice have the same MAC address. Also the information of MAC address typically has no other added value for the user of the computer or network. The drawback for assigning the location information to the prefix portion of the address is the global nature of the prefix portion. If the prefix is generated from the location information the routing will change and changes must be applied to all routers globally. The prefix solution also requires a change to the IPv6 standard.

### PURPOSE OF THE INVENTION

The purpose of the invention is to avoid the drawbacks of the prior art. Particularly the purpose of the invention is to utilize geographic location information in creating a globally unique IP address to stationary equipment, which is connected to the Internet, Intranet or other network connected to IP network. The purpose of the present invention is also to provide said addressing for mobile equipment.

### SUMMARY OF THE INVENTION

The geographical location information can be used instead of the MAC address in forming of the IP address. The main idea of the invention is following: Instead of MAC address the geographical location informations of the device is coded to the suffix address field. The geographic information can contain the longitude, the latitude and the altitude information. On the top of geographic coordinate information, also name, address, serial number or any other information giving value added information to the user can be coded into the address. Main principle is that the address remains unique in the link. The adoption of geographic location and other additional information can be made fully automatic with the help of positioning and other recognition technologies. The location information can be given also manually. The uniqueness of the address in the link is handled with the auto configuration techniques, which are already commonly known.

It is also possible to extend this geographical location based addressing to layer 3 router network. This can be done in subnet level addressing. The subnets are addressed based on the geographic location of the routers, which connect them to IP network.

Mapping of geographic address directly to IPv6 address field enables also all the ad-hoc, mesh and other networks, which have their addressing based on one, two, three or more dimensional geographic addresses, to seamlessly integrate into IP network. If the node in the geographically addressed network is stationary, the IP address configured -in this manner can be used also in the IP network to identify the host globally. If the node is mobile, a separate service is needed in the network, which map the geographic location to “fixed” IP addresses. These addresses can be formed based on the MAC addresses or generated by any other accepted manner. The geographic location of the mobile nodes can be presented by using a “mobile IP address” where the location is coded in the link address field, or by using any other method for coding the location information. This service can be generated for example by a separate server which is located either in the IP network or in the geographically addressed network. In this case the geographically addressed networks form one or several links from the IP network perspective. If the geographic location based addressing is used in the layer 3 networks, a similar service mapping the IP-addresses of the subnets and the geographic location based addresses must be available able either in the IP-network or in the geographically addressed subnet.

The advantage of the invention is, that with addressing based on the geographic location, the configuring of the link can be fully automatic, without the need of coordinating the allocation of unique MAC addresses between the device manufacturers. If the geographically based addressing is used in layer 3, the configuring and routing table generation of the network can be fully automatic. The further advantage is that the applications and the users can easily receive the geographic location information of the network device when it is inbuilt into the IP address of the device. The location information can be utilized in the geographically addressed network to improve the network performance; one example is to use it in the routing algorithm of an ad-hoc network to improve the routing performance. Further, this kind of addressing based on geographical location can be utilized in optimizing the radio connections between nodes, because the distance and direction of the destination node is known from the location-based addresses. Location based services and service discovery functions, like finding the nearest printer, are easy to realize as the addresses directly indicate the geographic location of the device. Also the geographically addressed networks are easy to integrate seamlessly to any IP based networks by using this principle. The further advantage is the compatibility with the present IPv6 applications. Utilization of the invention does not require any changes to the standards relating to IPv6.

### BRIEF DESCRIPTION OF THE DRAWINGS

FIG. 1 illustrates a structure of IPv 6 address generated from geographical location information.

FIG. 2 illustrates an example of an application network in which the geographical location information is used.

### DETAILED DESCRIPTION OF THE INVENTION

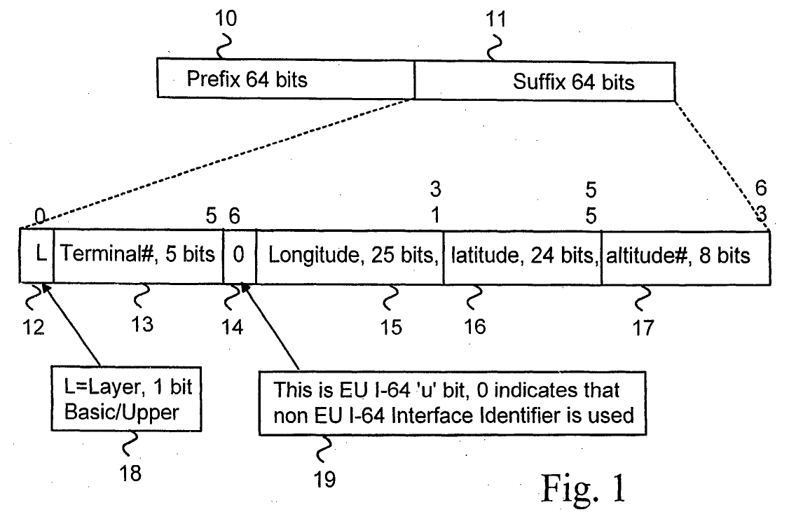

FIG. 1 illustrates a structure of IPv6 address generated from geographical location information. The IPv6 address is divided into two 64 bit parts, prefix 10 and suffix 11. The prefix part 10 indicates a router port where the respective link is connected. In the link the computers and other network elements are addressed with suffix part 11. The suffix part 11 has to be a unique address in the link to form a unique prefix and suffix pair. The suffix part is generated from geographical location information

The FIG. 1 illustrates a one possible structure of geographically generated suffix part. The suffix part 11 can be divided on Global Positioning Address (GPA). The GPA is based on geographical three dimensional addresses. The IPv6 specification does not apply any special restrictions to the utilization of the suffix part 11. In the invention the suffix part is divided into group of blocks.

The first block 12 describes the layer of the router. The layer can be basic or upper. The block is a flag and uses 1 bit. The second block 13 is the terminal number of the device. The second block 13 uses 5 bits. The third block 14 is a flag indicating whether the EU I-64 interface identifier is used. The fourth block 15 is the longitude. information and the block uses 25 bits. The fifth block 16 is the latitude information and the block uses 24 bits. The sixth block 16 contains the altitude information and it uses eight bits. The structure of the suffix is not fixed and the structure illustrated in the FIG. 1 is only one possible structure. The structure can be selected based on the applications needs. The part of the GPA informations could be assigned to the prefix part 10 but the utilization of the prefix part would require changes in the standard.

Each routing component in the network knows own and neighborhood cell locations. The routing element knows exactly the next element to which the packet is to be routed. The same information can be harnessed also in cases where a node forwards a packet to the next node. The component harnessing the geographical location information does not need to be a router. The location information consist of the direction and the distance of the next element. The next element can be a mobile device. When the networks radio device knows the exact location of the destinations, the direction and the distance information can be harnessed in the adjustment of the intensity of the transmission and the directivity of the antenna. The benefit of the invention is that when compared to regular radio system the radio transmission causes less interference with other stations and leads to better frequency efficiency.

In the embodiment of the invention the location information can be manually entered or computed with a known positioning technology. When the client is a mobile device the positioning technology is the only reasonable solution because the location information must be updated. The positioning can be done for example by utilizing a GPS-receiver or by cellular network (such as GSM or UMTS, for example) positioning methods. The changed address has to be updated in the register that controls the locations and addresses of mobile devices. When the position information is exact and up to date the variety of possible location based applications can be designed. For example the client has a mobile terminal capable of retrieving e-mail attachments and the attachment needs to be printed on a paper for signatory purposes. When the mobile device and the printer both have a unique location based IP address the document can be sent to the nearest available printer.

In the other embodiment the address assigned to the mobile device does not update the location information. The assigned location coordinates are copied from the router, and the router assigns a terminal device number for the mobile device. The accuracy of the positioning depends on cell size of the used router. For example in case of bluetooth router the accuracy is good enough for many services. The bluetooth router can be arranged for example to the office or a conference room. Assigning the unique terminal device number is particularly convenient in cases where the mobile device does not have means for accurate positioning.

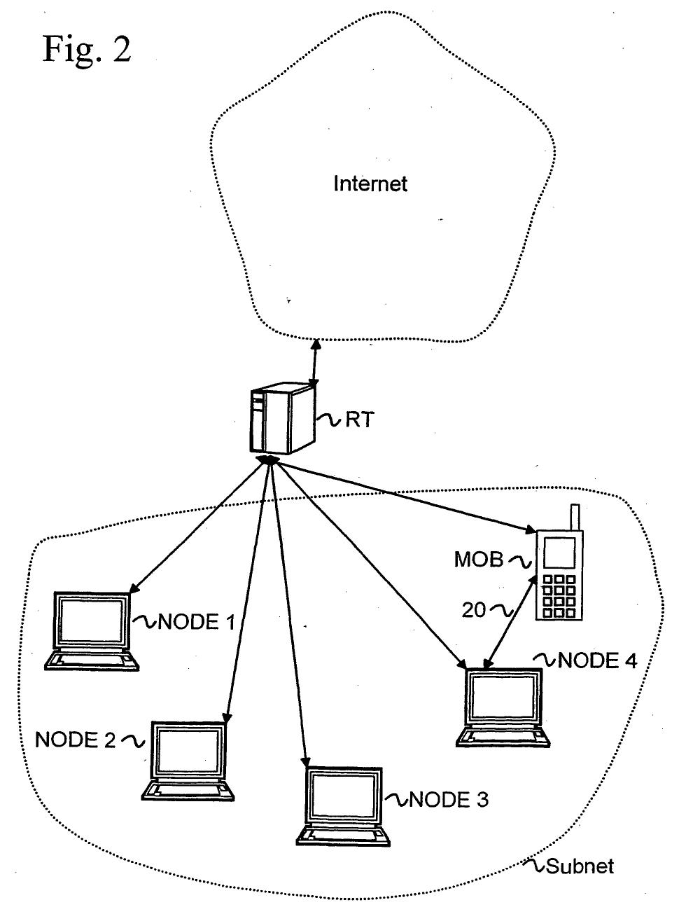

FIG. 2 illustrates an example of an application in which the geographic location information is harnessed in the suffix portion of the address. The system in the figure consists of a router. (RT) which routes data packets between the internet and subnet. In the subnet (Subnet), there is a group of clients, i.e. network nodes. The nodes can be fixed (NODE 1-4) or mobile (MOB). The benefit of the present invention is that it does not require any special hardware. With special location aware hardware further applications, such as network optimization or location based services, are implemented easily. The significant issue in applications is that the location information is local and assigned to subnetworks. In example, in a subnet with different nodes, it is possible that alternative embodiments of this invention can be utilized in parallel. In example, mobile node (MOB) address may be assigned according to geographical address of the router (RT), and the mobile node device number whereas some of the fixed nodes may be addressed in the subnet by addresses assigned according to their own geographical locations, and other fixed nodes are addressed by “normal” MAC-based addressing scheme. It is not necessary to all nodes have geographic location information based. address in the network unless the application, such as network optimization or a location based service requires it. It is also possible to establish direct connections between the clients such as connection 20, in which the mobile device is connected directly to the node 4. The direct connection is beneficial for example in cases where the bluetooth technology is available. Instead of the mobile device the connection can be established between nodes and peripherals that have ip-address of own.

The present invention is not restricted to the above description but other applications are possible when the inventive conception of the patent claims is fulfilled.

1-21. (Cancelled).

22. A method for generating unique internet protocol address from the geographical location data, in which the internet protocol address has a global prefix portion and a local suffice portion, wherein the geographical location information is coded in the suffix part of the address.

23. A method according to claim 22, wherein the geographical location is a three dimensional coordinate.

24. A method according to claim 22, wherein the geographical location information is a two dimensional coordinate.

25. A method according to claim 22, wherein the geographical location information includes additional information.

26. A method according to claim 25, wherein the additional information is node specific information such as terminal number, node name, node layer information, street address, serial number, color or weight.

27. A method according to claim 22, wherein the address based on the geographic location information assigned to a mobile device is updated when the mobile device moves and said new address is informed to the register that controls the location of said mobile device.

28. A method according to claim 22, wherein the address assigned to a mobile device consist of the device number and geographical location information of the router to which the mobile device is connected to.

29. A method according to claim 22, wherein the geographical location information is automatically detected.

30. A method according to claim 22, wherein the geographical information is manually entered.

31. A method according to claim 22, wherein the addressing of subnets of the network is based on the geographic location of the routers.

32. A method according to claim 22, wherein the addresses are used to improve the network performance by using the geographic location information in directing the radio signal to destination when radios are used in physical layer.

33. A router for routing internet protocol packets in which the unique address is based on geographical location information and has a global prefix portion and a local suffix portion, wherein the system harnesses the geographic location information coded to the suffice portion of the address in routing packets to the destination nodes located in the subnetwork.

34. A router according to claim 33, wherein the geographic location information is a three dimensional coordinate.

35. A router according to claim 33, wherein the geographic location information is a two dimensional coordinate.

36. A router according to claim 33, wherein the geographical location information includes additional information.

37. A router according to claim 36, wherein the additional information is node specific information such as terminal number, node name, street address, serial number, color or weight.

38. A router according to claim 33, wherein the router is arranged to update the address assigned to a mobile device when the mobile device moves.

39. A router according to claim 33, wherein the router is arranged to assign to a mobile device an address which consists of a device number and a geographical location information of the router to which the mobile device is connected to.

40. A router according to claim 33, wherein the router is arranged to query the geographic location information from the client attached to the network.

41. A router according to claim 33, wherein the router is arranged to assign the geographic location information and terminal device number to client attached to the network.

42. A router according to claim 33, wherein the router is arranged to utilize the geographic location information in directing the radio signal to destination when radios are used in physical layer.
